(19) United States
(12) Patent Application Publication
(10) Pub. No.: US 2024/0170799 A1
(43) Pub. Date: May 23, 2024

(54) Battery cell and battery module configured for stopping thermal propagation

(71) Applicant: SAMSUNG SDI CO., LTD., Yongin-si (KR)

(72) Inventors: Peter PARZ, Gratwein (AT); Jörg KILLMANN, Graz (AT); Istvan KONDOR, Bierbaum (AT)

(21) Appl. No.: 18/487,871

(22) Filed: Oct. 16, 2023

(30) Foreign Application Priority Data
Nov. 23, 2022 (EP) 22209076.3

(51) Int. Cl. H01M 50/342; H01M 10/613; H01M 10/625; H01M 10/647; H01M 10/6554; H01M 50/103; H01M 50/209; H01M 50/249; H01M 50/528; H01M 50/548; H01M 50/682

(52) U.S. Cl. CPC H01M 50/3425; H01M 10/613; H01M 10/625; H01M 10/647; H01M 10/6554; H01M 50/103; H01M 50/209; H01M 50/249; H01M 50/528; H01M 50/548; H01M 50/682; H01M 2220/20

(57) ABSTRACT

A battery cell includes: a housing having a prismatic shape with a venting side and a terminal side that is different from the venting side; an electrode assembly inside the housing; a terminal arranged on the terminal side; and a venting valve on the venting side. The venting valve is configured to switch between a closed state and an open state. The venting valve, when in the open state, forms a vent opening in the venting side of the housing, and the vent opening is at least 15% of the total area of the venting side.

### CROSS-REFERENCE TO RELATED APPLICATION

This application claims priority to and the benefit of European Patent Application No. 22209076.3, filed in the European Patent Office on Nov. 23, 2022, the entire content of which is incorporated herein by reference.

### BACKGROUND

### 1. Field

Aspects of embodiments of the present disclosure relate to a battery cell and a battery module configured for stopping thermal propagation.

### 2. Description of the Related Art

Recently, vehicles for transportation of goods and peoples have been developed that use electric power as a source for motion. Such an electric vehicle is an automobile that is propelled by an electric motor using energy stored in rechargeable batteries. An electric vehicle may be solely powered by batteries or may be a hybrid vehicle powered by, for example, a gasoline generator or a hydrogen fuel power cell. A hybrid vehicle may include a combination of electric motor and conventional combustion engine. Generally, an electric-vehicle battery (EVB or traction battery) is a battery used to power the propulsion of battery electric vehicles (BEVs). Electric-vehicle batteries differ from starting, lighting, and ignition batteries in that they are designed to provide power for sustained periods of time. A rechargeable (or secondary) battery differs from a primary battery in that it is designed to be repeatedly charged and discharged, while the latter is designed to provide an irreversible conversion of chemical to electrical energy. Low-capacity rechargeable batteries are used as power supplies for small electronic devices, such as cellular phones, notebook computers, and camcorders, while high-capacity rechargeable batteries are used as power supplies for electric and hybrid vehicles and the like.

Generally, rechargeable batteries include an electrode assembly including a positive electrode, a negative electrode, and a separator interposed between the positive and negative electrodes, a case receiving (or accommodating) the electrode assembly, and an electrode terminal electrically connected to the electrode assembly. An electrolyte solution is injected into the case to enable charging and discharging of the battery via an electrochemical reaction of the positive electrode, the negative electrode, and the electrolyte solution. The shape of the case, such as cylindrical or rectangular, may be selected based on the battery's intended purpose. Lithium-ion (and similar lithium polymer) batteries, widely known via their use in laptops and consumer electronics, dominate the most recent electric vehicles in development.

Rechargeable batteries may be used as a battery module formed of a plurality of unit battery cells coupled together in series and/or in parallel to provide a high energy content, such as for motor driving of a hybrid vehicle. The battery module may be formed by interconnecting the electrode terminals of the plurality of unit battery cells in a manner depending on a desired amount of power and to realize a high-power rechargeable battery.

Battery modules can be constructed either in a block design or in a modular design. In the block design, each battery is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected together in series to provide a desired voltage. The battery modules may include submodules with a plurality of stacked battery cells, and each stack includes cells connected in parallel that are, in turn, connected in series (XpYs) or cells connected in series that are, in turn, connected in parallel (XsYp).

A battery pack is a set of any number of (usually identical) battery modules. The battery modules may be configured in series, parallel, or a mixture of both to deliver the desired voltage, capacity, and/or power density. Components of a battery pack include the individual battery modules and the interconnects, which provide electrical conductivity between the battery modules.

A battery system may also include a battery management system (BMS), which is any suitable electronic system that is configured to manage the rechargeable battery, battery module, and battery pack, such as by protecting the batteries from operating outside their safe operating area, monitoring their states, calculating secondary data, reporting that data, controlling its environment, authenticating it, and/or balancing it. For example, the BMS may monitor the state of the battery as represented by voltage (e.g., a total voltage of the battery pack or battery modules and/or voltages of individual cells), temperature (e.g., an average temperature of the battery pack or battery modules, coolant intake temperature, coolant output temperature, and/or temperatures of individual cells), coolant flow (e.g., flow rate and/or cooling liquid pressure), and current.

A BMS may protect the battery pack from operating outside its safe operating area. Operation outside the safe operating area may be indicated by over-current, over-voltage (during charging), over-temperature, under-temperature, over-pressure, and ground fault or leakage current detection. The BMS may prevent the battery from operating outside its safe operating parameters by including an internal switch (e.g., a relay or solid-state device) that opens if the battery is operated outside its safe operating parameters, requesting the devices to which the battery is connected to reduce or even terminate using the battery, and actively controlling the environment, such as through heaters, fans, air conditioning or liquid cooling.

Mechanical integration of such a battery pack incorporates suitable mechanical connections between the individual components of, for example, battery modules, and between them and a supporting structure of the vehicle. These connections are designed to remain functional and safe throughout the average service life of the battery system. Furthermore, installation space and interchangeability standards must be considered, especially in mobile applications.

Mechanical integration of battery modules may be achieved by providing a carrier framework and by positioning the battery modules thereon. Fixing the battery cells or battery modules may be achieved by using fitted depressions in the framework or by mechanical interconnectors, such as bolts or screws. In other examples, the battery modules are confined by fastening side plates to lateral sides of the carrier framework. Moreover, cover plates may be fixed atop and below the battery modules.

The carrier framework of the battery pack is mounted to a carrying structure of the vehicle. When the battery pack is fixed at the bottom of the vehicle, the mechanical connection may be established from the bottom side by, for example, bolts passing through the carrier framework of the battery pack. The framework is generally made of aluminum or an aluminum alloy to lower the total weight of the construction.

An active or passive thermal management system to provide thermal control of the battery pack is often included to safely use the at least one battery module by efficiently emitting, discharging, and/or dissipating heat generated from its rechargeable batteries. If the heat emission, discharge, and/or dissipation is not sufficiently performed, temperature deviations may occur between respective battery cells, such that the battery module may no longer generate a desired (or designed) amount of power. In addition, an increase of the internal temperature can lead to abnormal reactions occurring therein, and thus, charging and discharging performance of the rechargeable deteriorates and the life-span of the rechargeable battery is shortened. Thus, cell cooling for effectively emitting, discharging, and/or dissipating heat from the cells is important.

Exothermic decomposition of cell components may lead to a so-called thermal runaway. Generally, thermal runaway describes a process that accelerates due to increased temperature, in turn releasing energy that further increases temperature. Thermal runaway occurs in situations when an increase in temperature changes the conditions in a way that causes a further increase in temperature, often leading to a destructive result. In rechargeable battery systems, thermal runaway is associated with strong exothermic reactions that are accelerated by temperature rise. These exothermic reactions include combustion of flammable gas compositions within the battery housing. For example, when a cell is heated above a critical temperature (typically above about 150° C.), the cell can transition into a thermal runaway. The initial heating may be caused by a local failure, such as a cell internal short circuit, heating from a defective electrical contact, or short circuit to a neighboring cell. During the thermal runaway, a failed battery cell, such as a battery cell that has a local failure, may reach a temperature exceeding about 700° C. Further, large quantities of hot gas are ejected (or emitted) from inside of the failed battery cell through the venting opening in the battery housing into the battery pack. The main components of the vented gas are H₂, CO₂, CO, electrolyte vapor, and other hydrocarbons. The vented gas is therefore flammable and potentially toxic. The vented gas also causes a gas-pressure to increase inside the battery pack.

Lithium-ion batteries can experience thermal runaway. Thermal runaway may be initiated by an internal short circuit within the battery cell, which causes the battery cell to rapidly heat up. The electrolyte contained within the battery evaporates, thus increasing internal pressure, which in turn opens (or bursts) the venting valve of the battery cell such that the battery cell starts venting. As the internal heating continues, the internal parts (or components) of the battery cell melt and are ejected together with the venting gas. Eventually, the entire cell can may melt.

The term “thermal propagation” denotes an event that occurs when the thermal runaway of one battery cell initiates thermal runaway in one or more other (e.g., adjacent) battery cells. This may lead to a chain reaction, in the course of which the entire battery pack and, possibly, its surrounding (e.g., a vehicle) burn down.

Tests on new generations of battery cells show that very high temperatures (e.g., over about 1000° C.) are generated during thermal runaway and about 1 MJ is released. Experiments show that a short-term thermal energy input of 60 kJ into a battery cell is sufficient to start a thermal event therein. Furthermore, due to the high gas pressure during thermal runaway, major parts of the electrode stack (e.g., the jelly roll) of the battery cell may be ejected from the battery cell. These electrically conductive parts may lead to short circuits and arcs inside a closed (e.g., sealed) battery pack. This, in turn, may initiate thermal runaway of other battery cells, thus leading to thermal propagation and, finally, the complete destruction of the battery.

In related art examples, the above-described processes may lead to the total destruction of a battery pack and/or the total destruction of a vehicle equipped with the battery pack, and thus, implicates a high safety risk for people in the vicinity of the battery pack.

### SUMMARY

There is a need to inhibit thermal propagation or to at least considerably reduce the probability (e.g., the risk) of thermal propagation. For example, there is a need for a battery cell, a battery module, and a battery pack that allows for inhibiting thermal propagation or at least for considerably reducing the probability (risk) of thermal propagation. Also, there is a need for vehicles, in which thermal propagation in its power sources is inhibited or the risk of occurrence of thermal propagation in its power sources is at least considerably reduced.

Embodiments of the present disclosure overcome or reduce (or mitigate) at least some of the drawbacks of the related art and, in particular, provide a battery cell, a battery module, and a battery pack that inhibits thermal propagation or at least considerably reduces the probability of thermal propagation. Embodiments of the present disclosure also provide a vehicle, in which thermal propagation in its power sources is inhibited or the risk of occurrence of thermal propagation in its power sources is at least considerably reduced.

The present disclosure is defined by the appended claims and their equivalents Any disclosure lying outside the scope of the claims and their equivalents is intended for illustrative as well as comparative purposes.

According to a first embodiment of the present disclosure, a battery cell includes: a housing having a prismatic shape with a venting side and a terminal side that is different from the venting side; an electrode assembly inside the housing; a terminal arranged on the terminal side; and a venting valve on the venting side. The venting valve is configured to switch between an open state and a closed state, and the venting valve, when in the open state, forms a vent opening in the venting side of the housing. The vent opening is at least 15% of the total area of the venting side.

According to a second embodiment of the present disclosure, a battery module includes: a plurality of battery cells, each of the battery cells being a battery cell according to the above-described first embodiment. Each battery cell is arranged such that the venting side thereof faces into a first direction.

According to a third embodiment of the present disclosure, a battery system includes: a battery cell according to the above-described first embodiment and/or a battery module according to the above-described second embodiment.

According to a fourth embodiment of the present disclosure, a vehicle includes: a battery module according to the above-described second embodiment and/or a battery system according to the above-described third embodiment.

Further aspects and features of the present disclosure can be learned from the dependent claims and/or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a schematic perspective view of a battery cell according to the related art.

FIGS. 2A and 2B schematically illustrate a top view and a cross-sectional view of the battery cell shown in FIG. 1.

FIGS. 3A and 3B schematically illustrate a cross-sectional view and a bottom view of a battery cell according to an embodiment of the present disclosure.

FIGS. 4A, 4B, and 4C are schematic illustrations of processes within a related art battery module when a thermal event occurs in one of the battery cells.

FIGS. 5A, 5B, and 5C are schematic illustrations of processes within a battery module according to an embodiment of the present disclosure when a thermal event occurs in one of the battery cells.

### DETAILED DESCRIPTION

Reference will now be made in detail to embodiments, examples of which are illustrated in the accompanying drawings. Aspects and features of the present disclosure, and implementation methods thereof, will be described with reference to the embodiments illustrated in the accompanying drawings. Accordingly, processes, elements, and techniques that are not considered necessary for those having ordinary skill in the art to have a complete understanding of the aspects and features of the present disclosure may be omitted or may be only briefly described.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term “substantially,” “about,” and similar terms are used as terms of approximation and not as terms of degree, and are intended to account for the inherent deviations in measured or calculated values that would be recognized by those of ordinary skill in the art. Further, if the term “substantially” is used in combination with a feature that is or could be expressed using a numeric value, the term “substantially” denotes a range of +/−5% of the value centered on the value.

Herein, the terms “upper” and “lower” are defined according to the x-axis of a Cartesian coordinate system, wherein the x-axis is oriented downwards. For example, an upper cover is positioned at a lower part of the x-axis, and a lower cover is positioned at an upper part of the x-axis. However, spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Aspects and features of the present disclosure, and methods of accomplishing the same, may be understood more readily with reference to the following detailed description of embodiments and the accompanying drawings. Hereinafter, embodiments of the present disclosure will be described in more detail with reference to the accompanying drawings. The present disclosure may, however, be embodied in various different forms and should not be construed as being limited to the embodiments illustrated herein. Rather, these embodiments are provided as examples so that this disclosure will be thorough and complete and will fully convey the aspects and features of the present disclosure to those skilled in the art.

The electronic or electric devices and/or any other relevant devices or components according to embodiments of the present disclosure described herein may be implemented utilizing any suitable hardware, firmware (e.g., an application-specific integrated circuit), software, or a combination of software, firmware, and hardware. Further, the various components of these devices may be implemented on a flexible printed circuit film, a tape carrier package (TCP), a printed circuit board (PCB), or formed on one substrate. The electrical connections or interconnections described herein may be realized by wires or conducting elements, for example, on a PCB or another kind of circuit carrier. The conducting elements may comprise metallization, e.g., surface metallizations and/or pins, and/or may comprise conductive polymers or ceramics. Further electrical energy might be transmitted via wireless connections, for example, using electromagnetic radiation and/or light.

Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as a random-access memory (RAM). The computer program instructions may also be stored in other non-transitory computer readable media such as, for example, a CD-ROM, flash drive, or the like.

Also, a person of skill in the art should recognize that the functionality of various computing devices may be combined or integrated into a single computing device, or the functionality of a particular computing device may be distributed across one or more other computing devices without departing from the scope of the exemplary embodiments of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to a first aspect of the present disclosure, a battery cell may include: a housing having a prismatic shape with a venting side and a terminal side that is different from the venting side; an electrode assembly inside the housing; a terminal arranged on the terminal side; a venting valve on the venting side. The venting valve is configured to switch between a closed state and an open state, and when in the open state, the venting valve forms a vent opening in the venting side that extends over at least 15% of the area of the venting side.

The term “prismatic shape,” as used with reference to the housing of the battery cell, denotes that the outer surface or outer appearance of the battery cell housing exhibits the geometric form of a prism or substantially the form of a prism. For example, the (outer surface or appearance of the) housing may have a cuboid shape, such as the shape of a right prism having a rectangular basis. However, in some embodiments, the housing may have the shape of a prism (right) prism with a hexagonal basis. However, the housing may have other shapes that are prismatic or substantially prismatic. For example, a substantially prismatic battery cell housing may have beveled or rounded edges (instead of sharp edges) and/or beveled or rounded corners (instead of sharp corners). In one embodiment, the shape of the housing corresponds to the shape of a right prisms, for example, prisms in which the joining edges and surfaces of the side faces are perpendicular to the bases. However, in some embodiments, the shape of the housing may correspond to prims other than right prisms.

The term “electrode assembly” shall refer to an electrode stack (e.g., a jelly roll). However, the electrode assembly may include electric connections configured to connect with terminals, which may be arranged on the terminal sides of the battery cell.

In some embodiments, the venting valve may open more than 15% of the area of the venting side when in the open state.

The venting valve may be configured to be in the open state or to switch into the open state when the pressure inside the battery cell exceeds a reference value and to remain or switch into the closed state otherwise.

The pressure inside the battery cell may be a gas pressure (e.g., the pressure of vaporized electrolytes) and/or a pressure of molten material (e.g., molten parts of the jelly roll). In the following, a pressure exceeding the reference value is referred to as “overpressure.”

In an embodiment of the battery cell, the venting side is configured to be a bottom side of the battery cell.

The term “bottom side” shall refer to that side of the prismatic battery cell housing that faces downwardly in the direction of the gravity force.

Accordingly, the battery cell may be configured to be used in an orientation in space in which the venting side faces downwardly in the direction of the gravity force.

Then, when the battery cell is held or arranged in such orientation, gravity acts on any material passing through the vent opening, improving the ejection of material through the venting opening. This applies irrespectively of the state of the material, that is, regardless of whether the material is in a solid state, a liquid state, or a gas state.

In embodiments, the venting side may be planar or essentially planar and arranged perpendicular to a first direction. Then, when the battery cell is held or arranged in an orientation in which the venting side is the bottom side, the first direction may correspond or may be parallel to the direction of gravity.

The housing may have a first lateral side and a second lateral side. The first lateral side and the second lateral side may each be planar or substantially planar. The first lateral side and the second lateral side may be shaped congruently to each other. The first lateral side and the second lateral side may each have a rectangular shape.

In embodiments, the first lateral side and the second lateral side may each extend perpendicularly to a second direction that is oriented non-parallel to the first direction. The second direction may be oriented perpendicular to the first direction.

Further, the housing may have a front side and a rear side. The front side and the rear side may each be planar or substantially planar. The front side and the rear side may be shaped congruently to each other. The front side and the rear side may each have a rectangular or a hexagonal shape. The front side may be configured to abut to a rear side of an adjacent battery cell have the same shape as the battery cell described above. The front side may be configured to be fixed (e.g., by an adhesive material) to the rear side of another battery cell. Similarly, the rear side of the battery cell may be configured to abut to a front side of an adjacent battery cell that is shaped identically to the battery cell described above. The rear side may be configured to be fixed (e.g., by an adhesive material) to the front side of another battery cell.

In embodiments, the front side and the rear side may each extend perpendicular to a third direction that is oriented non-parallel to the first direction and non-parallel to the second direction. The third direction may be oriented perpendicularly to the first direction. The third direction may be oriented perpendicularly to the second direction. The third direction may be oriented perpendicularly to the first direction and the second direction.

In an embodiment of the battery cell, the vent opening is configured to let molten material and particles pass from the inside of the battery cell (e.g., the inside of the housing) to the outside of the battery cell.

Here and in the following, the term “inside of the battery cell” has the meaning of “inside the housing of the battery cell.” Correspondingly, the term “outside the battery cell” shall have the meaning of “outside the housing of the battery cell.”

Then, in case of a thermal event, such as a thermal runaway, any molten material, vent gas, and/or particles entrained with the molten material and/or the vent gas can be ejected from the inside of the battery housing to the outside of the battery housing through the vent opening, the ejection being caused by the pressure generated inside the battery cell in case of a thermal event. When the battery cell, during use and, thus, during the thermal event, is oriented such that the venting side faces downwardly, i.e., in the direction of the gravity force, any molten material, vent gas, and/or particles entrained with the molten material and/or the vent gas is ejected from the battery cell's inside not only due to the internal pressure of the battery cell but also by the gravity force. In embodiments described in more detail below, also parts of material of the electrode assembly that have detached from their fixed arrangement within the battery cell housing may be ejected through the venting opening.

In an embodiment of the battery cell, the vent opening is configured to let parts of the electrode assembly mechanically that have become detached from the inside of the battery cell pass to the outside of the battery cell.

The term “detached parts” of the electrode assembly shall refer to parts of the electrode assembly that are not molten (e.g., that are in a solid state) in case of a thermal event but have detached from the fixed arrangement inside the battery cell housing and/or have detached from other parts of the electrode assembly, by which they have been held in a fixed position in the original state of the battery cell. The original state of the battery cell may be defined, here and in the following, as a state, in which no thermal event has yet occurred in the battery cell.

In an embodiment of the battery cell, the electrode assembly is fixed inside the battery cell by an anchorage, and the electrode assembly is configured to slide through the venting opening when the venting valve is in the open state and the electrode assembly has been detached from the anchorage.

The anchorage may include one or more brackets or bracings. For example, the outer surface of parts of the electrode assembly that are in fixed connection with the anchorage may become at least partly fused due to the temperature and/or the pressure generated inside the battery cell housing such that the fixed connection of the electrode assembly to the anchorage is loosened. Then, in case of a thermal event, the battery assembly is configured to be ejected through the vent opening provided by the opened venting valve. The ejection may be caused by the (over-)pressure inside the battery cell housing and/or by gravity.

It suffices that the electrode assembly, or at least (solid and/or molten) parts of the electrode assembly, fit in one direction through the venting opening formed by the venting valve when it is in the open state. This direction may be a direction parallel to a straight line running through the vent opening as well as through the electrode assembly when the battery cell is in an original state.

In an embodiment of the battery cell, the venting valve, when in the open state, forms a venting opening that opens, for example, at least 20% or at least 25% of the surface area of the venting side. In some embodiments, the venting valve, when in the open state, forms a venting opening that opens at least 30% of the surface area of the venting side. In embodiments of the battery cell, the venting valve, when in the open state, may form a venting opening that opens at least 40%, at least 50%, or at least 60% of the surface area of the venting side. In some embodiments, the venting valve, when in the open state, forms a venting opening that opens at least 70%, more preferably at least 80%, or most preferably at least 90% of the surface area of the venting side.

Then, large parts of the electrode assembly (e.g., the jelly roll/stack) can be ejected from the interior of the battery cell such that heat conduction to the neighboring cells is prevented. Also, the larger the open area formed by the venting valve when in the open state, the higher is the probability that major parts of the electrode assembly (being destroyed by thermal runaway) are able to drop out of the battery cell through the venting valve.

The area of the venting side that is opened by the venting valve in the open state may be a centered (or central) area of the venting side. For example, when the venting side extends along the second direction perpendicular to the first and second lateral sides, the opened area may be centered on the venting side with respect to the second direction. Then, the remaining non-open portions of the area of the venting side are adjacent to each of the edges of the venting side formed with one of the lateral sides.

In embodiments, the non-open portions of the venting side may be configured as supporting areas at where the battery cell housing may be mechanically supported when being placed or arranged in a battery module.

In an embodiment of the battery cell, the venting valve, when in the open state, forms a venting opening that opens the venting side to 100% or at least between 98% and 100%.

In such embodiments of the battery cell, the venting opening provides a maximally opened area of the venting side possible.

In an embodiment of the battery cell, the housing includes two terminal sides arranged as opposite sides of the housing.

In embodiments, the two terminal sides may be the lateral sides of the battery cell housing. For example, a first terminal side may correspond to the first lateral side, and a second terminal side may correspond to the second lateral side. In other embodiments, however, a first terminal side may correspond to one of the lateral sides of the housing, and a second terminal side may correspond to a side of the housing that is arranged opposite to the venting side with respect to the housing.

In an embodiment of the battery cell, one side of the battery housing is a cooling side configured to be cooled by an external cooler.

Then, in such embodiments, the battery cell can be cooled by the external cooler.

The cooling side of the battery housing may be made of or at least includes a material having a high heat conductivity.

The cooling side may not be identical with the venting side and also may not be identical with each of the terminal sides. For example, the terminal side may correspond to the lateral sides of a battery cell, and the cooling side may then correspond to the side of the housing arranged opposite to the venting side with respect to the housing. In other embodiments, however, the cooling side may correspond to one of the lateral sides, and one of terminal sides may correspond to the other one of the lateral sides, while the other one of the terminal sides may correspond to the side of the housing being arranged opposite to the venting side with respect to the housing.

According to a second aspect of the present disclosure, a battery module may include: a plurality of battery cells, each of the battery cells being a battery cell as described above, and each battery cell is arranged such that the venting side of the battery cell faces into a first direction.

Then, the venting sides of the battery cells face into the same direction. Then, for each of the battery cells in the battery module, the first direction corresponds to the first direction as defined in the context of the second aspect of the present disclosure. In embodiments, the venting side of each battery cell may be arranged, in the battery module, perpendicular to the first direction. Then, when the battery module is oriented (e.g., held, arranged, mounted, and the like) in space such that the first direction corresponds to the direction of the gravity force, the venting sides of each of the battery cells in the battery module faces downwardly.

In such a battery module, thermal propagation is inhibited or, at least, the risk of thermal propagation is considerably reduced.

Some aspects and features of the present disclosure include improving the removal of generated heat from the vicinity of battery cells and ensuring that particle ejecta cannot contact other battery cells.

Thus, the battery module according to embodiments of the present disclosure inhibits thermal propagation by geometric design, and avoids total destruction of the battery module or a battery pack including the battery module, avoids total destruction of vehicle, and reduces risk for safety of people in the vicinity of the battery module and/or battery pack.

Some aspects and features of the battery module include: due to changing the design of the battery cell (e.g., changing the venting and terminal positioning) in comparison to related art designs, in the case of a thermal event, the hot electrode stack (e.g., the jelly roll) is ejected from the battery cell housing to a safe environment and is, therefore, no longer in contact with neighboring battery cells. Consequently, heat transfer is interrupted, and other battery cells cannot go into thermal runaway.

A container (trough) collects the (parts of the) electrode stack (such as the jelly roll) at the bottom of the module. In embodiments, the container/trough can also act as a bollard protection plate.

In embodiments, the battery cells have terminals at the lateral sides and can, therefore, be cooled at the top side. At the bottom side of the battery cells, there is a large venting area, so that the electrode stack (e.g., the jelly roll) can fall out in the case of a thermal event.

In embodiments of the battery module, each of the lateral sides of each of the battery cells may be arranged perpendicular to a second direction non-parallel (e.g., perpendicular) to the first direction. In such embodiments of the battery module, each battery cell may have lateral sides each being configured as a terminal side.

In embodiments of the battery module, the battery cells may be arranged in at least one battery cell stack extending non-parallel to the first direction. For example, in each of the at least one battery cell stacks, the battery cells may be arranged consecutively along a third direction non-parallel (e.g., perpendicular) to the first direction and non-parallel (e.g., perpendicular) to the second direction. In a stack, the venting sides of each of the battery cell stack may be arranged on the same (virtual) plane. In embodiments of the battery module, the venting sides of each of the battery cells may be arranged on the same (virtual) plane.

In an embodiment of the battery module, the battery module may further include one or more troughs, and, for each of the battery cells, one of the one or more troughs extends parallel to the venting side of the battery cell, is positioned in front of the venting side of the battery cell, and is arranged spaced apart, with regard to the first direction, from the venting side of the battery cell.

Each of the troughs or at least an area of the each of the troughs may have a planar or essentially planer shape. In embodiments of the battery module, each of the venting sides is oriented perpendicular to the first direction, and the troughs may each be arranged perpendicular to the first direction.

For example, in embodiments of the battery module, a venting side of each battery cell is arranged perpendicular to a first direction, and the one or more troughs are arranged below the venting sides when the battery module is oriented (e.g., held, arranged, mounted, and the like) in space such that the first direction corresponds to the direction of the gravity force. Then, in case of the occurrence of a thermal event in one or more of the battery cells, the venting valves of the battery cells affected by the thermal event may open and, due to the (over-)pressure inside the affected battery cells and the gravitational force, particles, molten parts or detached parts of the electrode assembly inside each of the affected battery cells may be ejected out of the battery cells and fell down onto the (at least one) trough. For example, solid or liquid parts of the ejecta are then collected on the at least one trough below the plurality of battery cells and may remain and cool down there.

Further, in such embodiments, the troughs may then be spaced apart, with regard to the first direction, from each of the venting sides by a distance or at least by the distance. The distance may be chosen such that the heat generated by the ejecta collected on the at least one trough does not cause a thermal event in battery cells not yet affected by the thermal event and, further, does not drive further thermal events, which already occur in at least some (e.g., in one or more) of the battery cells. Thus, the space where the solid and molten ejecta are collected on the one or more troughs is a “safe space” in the sense that the ejecta collected there do no longer contribute to driving or maintaining the procedure of a thermal event in the affected battery cells.

Embodiments of the battery module may include only a single trough that is arranged in front of the venting sides of each of the battery cells (irrespectively of the arrangement of the battery cells in one or more stacks). In other embodiments, the battery module may include at least two battery cell stacks, and at least two troughs are used such that for each of the battery cell stacks, one of the troughs is arranged in front of the venting sides of each of the battery cells of that battery cell stack.

In an embodiment of the battery module, at least some of the troughs are formed by a bollard protection plate. In embodiments, each of the troughs may be formed (or provided) by a bollard protection plate.

In an embodiment of the battery module, at least some of the troughs are made of a material configured to withstand high temperatures, such as steel. In some embodiments, each of the troughs may be made of a material configured to withstand high temperatures, such as steel.

In an embodiment of the battery module, the battery module may further include a cooler in thermal connection to the cooling side of each of the battery cells.

The cooling side of each of the battery cells faces into a second direction.

For example, in some embodiments, the second direction may be (anti-)parallel to the first direction, while, however, the orientation of the second direction is opposite to the orientation of the first direction. In other words, in such embodiments, the first and the second direction may be oriented opposite to each other. Then, in those embodiments, each of the battery cells can be cooled by the cooler in thermal contact with the housing (e.g., mechanically contacts or abuts against the housing) of each of the battery cells on a location opposite to the venting sides.

However, in other embodiments, the second direction may be perpendicular to the first direction. In such embodiments, the cooler may be in thermal contact with one of the lateral sides of each of the battery cells in the battery module.

In embodiments, the cooler may include (or may be) at least one cooling plate.

In embodiments, the cooler (e.g., the cooling plate) may have a cooling channel configured for guiding a coolant through itself. In embodiments, the cooling channel may have a plurality of cooling sub-channels. The cooling channel may abut against the cooling side of each of the battery cell housings. The cooling channel may have at least one cooling channel inlet for supplying the coolant channel with a coolant (e.g., a cooling liquid) provided by an external coolant supply. Further, the coolant channel may have at least one cooling channel outlet for discharging coolant from the coolant channel into an external coolant collection device. The coolant supply and the coolant collection device may be the same device.

In embodiments, the cooling channel may be in direct thermal contact with the cooling sides of the battery cells. In other embodiments, the cooling channel may be in thermal contact with the at least one cooling plate, and each of the at least one cooling plate is, in turn, in thermal contact with the cooling side of at least some of the battery cells.

According to a third aspect of the present disclosure, a battery system includes: one or more battery cells described above; and/or one or more battery modules described above.

According to a fourth aspect of the present disclosure, a vehicle includes: at least one battery module described above; and/or at least one battery system described above.

The vehicle may be a hybrid vehicle or a fully electric vehicle.

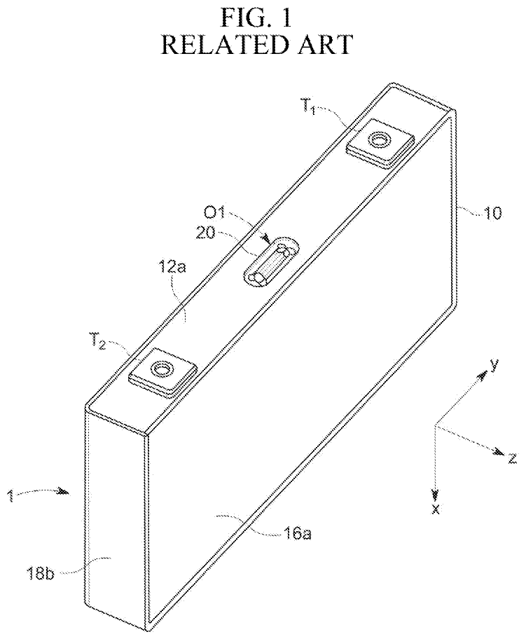

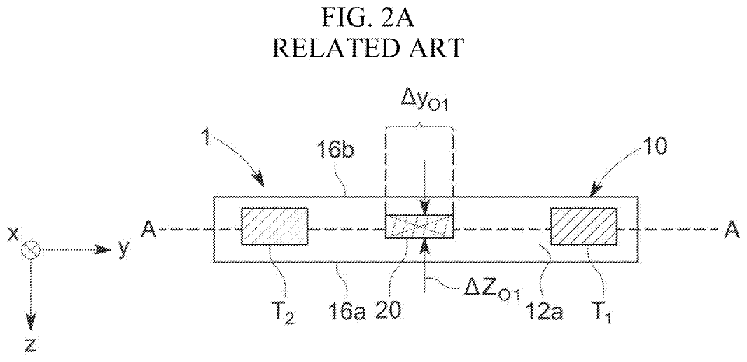

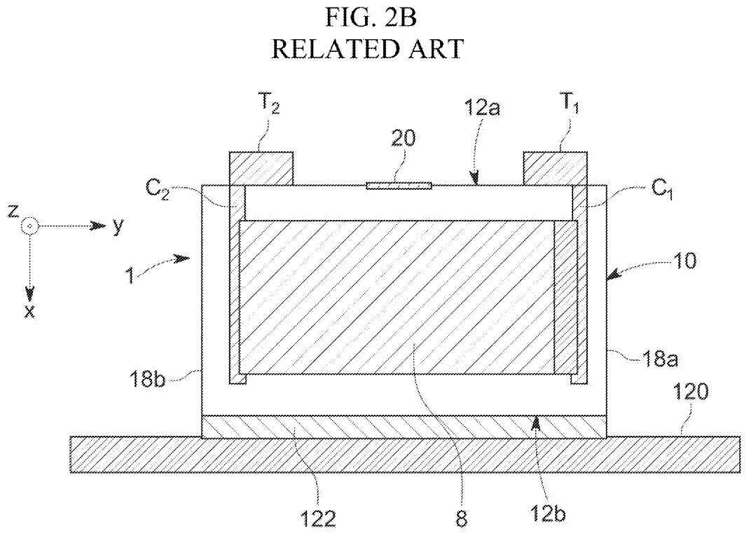

Referring to FIGS. 1, 2A, and 2B, an example of a related art battery cell 1 used in battery systems for hybrid or fully electric vehicles is schematically illustrated. FIG. 1 is a schematic perspective view, while FIG. 2A is a top view and FIG. 2B is a cross-sectional view taken along a plane parallel to the x-y-plane of the coordinate system along the line A-A in FIG. 2A.

The battery cell 1 has a housing 10 with a prismatic (e.g., cuboid) shape. A first terminal T₁ and a second terminal T₂ are arranged on an upper side (e.g., upper side face) 12a of the housing 10 (e.g., the battery cell's upper side surface facing against the x-direction of the coordinate system). The terminals T₁, T₂ allow for an electrical connection to the battery cell 1. The first terminal T₁ may be the negative terminal of the battery cell 1, and the second terminal T₂ may be the positive terminal of the battery cell 1. Furthermore, a venting valve 20 is arranged on the upper side face 12a between the first terminal T₁ and the second terminal T₂. The venting valve 20 has two states, a closed state and an open state, and is configured to switch between these two states. For example, the venting valve 20 is configured to be in the open state or to switch into the open state when the pressure inside the battery cell 1 exceeds a reference value (e.g., a predetermined value) and to remain in or switch back into the closed state otherwise. In the open state, the venting valve 20 provides a vent opening O1 in the upper side 12a of the battery cell 1 as depicted in FIGS. 1 and 2. Thus, vent gas can be ejected from the battery cell 1 (e.g., from the inside of the housing 10 to the outside of housing 10) through the vent opening O1 provided by the open venting valve 20 in case of a thermal event, such as a thermal runaway, occurring in the battery cell 1.

An electrode stack 8 (also called an electrode assembly or a “jelly roll”) is surrounded by an electrolyte solution inside the housing 10. The electrode stack 8 is electrically connected with the first terminal T₁ via a first electric connection (e.g., a first current collector) C₁, and the electrode stack 8 is electrically connected with the second terminal T₂ via a second electric connection (e.g., a second current collector) C₂.

Due to the housing 10 of the battery cell 1 having a cuboid shape, the housing 10 has a bottom side 12b arranged opposite to the upper side 12a (see, e.g., FIG. 2B). The battery cell 1 also has of a first lateral side 18a facing into the y-direction and a second lateral side 18b opposite to the first lateral side 18a as well as a front side 16a facing into the z-direction and a rear side 16b arranged opposite to the front side 16a.

In the illustrated embodiment, the bottom side 12b of the housing 10 acts as a cooling side of battery cell 1. For example, the bottom side 12b may be made of a material having relatively high thermal conductivity. The bottom side 12b of the housing 10 may be glued, using a thermal interface material (TIM) as an adhesive layer 122, onto a cooling plate 120. Thus, heat can be dissipated from the inside of housing 10 to the cooling plate 120 via the adhesive layer 122 of TIM, which cools the battery cell 1.

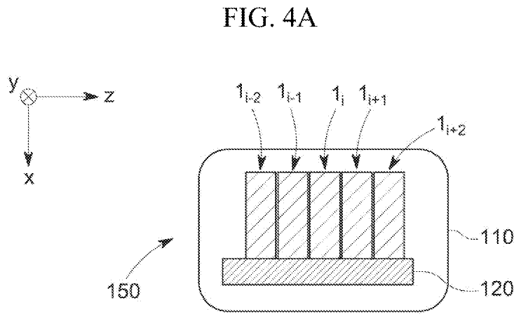

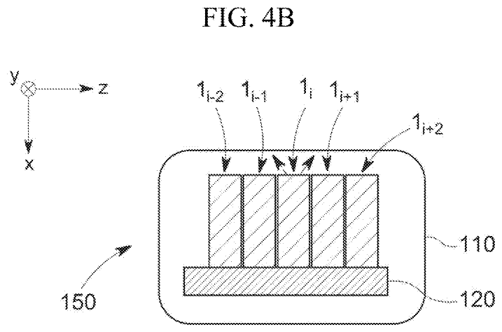

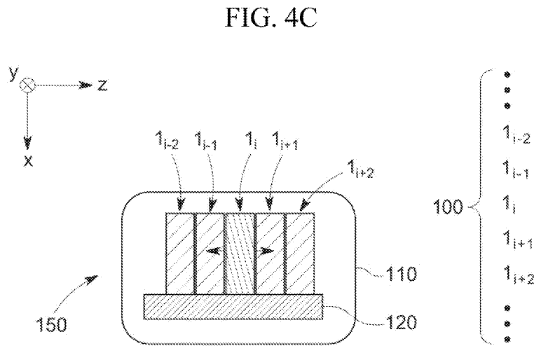

A battery module or battery system commonly includes one or more stacks of battery cells. Usually, the individual battery cells of one of the stacks are shaped identically or essentially identically to each other. For example, a battery cell stack can be assembled by stacking together a plurality of battery cells, each being designed like the battery cell 1 shown in FIGS. 1 and 2 along a direction parallel to the axis z of the coordinate system. Then, a stack of battery cells is formed into a battery cell stack 100 including the battery cells 1ᵢ₋₂, 1ᵢ₋₁, 1ᵢ, 1ᵢ₊₁, and 1ᵢ₊₂ schematically depicted in FIG. 4A as a member of a battery module 150 (see below). Of course, the battery cell stack 100 may include more battery cells than are depicted in FIG. 4, for example, the stack of battery cells 1ᵢ₋₂, 1ᵢ₋₁, 1ᵢ, 1ᵢ₊₁, and 1ᵢ₊₂ may be continued or expanded, with regard to the orientation of FIG. 4, to the left and/or the right by a plurality of further battery cells 1. The further battery cells 1 may also be shaped like the battery cell 1 shown in FIGS. 1, 2A, and 2B). The terminals T₁, T₂ of the various battery cells 1 in the battery cell stack 100 (see, e.g., terminals T₁ and T₂ in FIGS. 1 and 2) may be electrically interconnected to each other in a suitable manner by, for example, busbars.

FIGS. 4A-4C provide a schematic cross-sectional view of a related art battery module 150 taken along the z-axis through the battery cell stack 100 described above. However, the battery module 150 may also include further battery cell stacks 100. The battery cell stack 100 and, if applicable, any further battery cell stacks 100, are accommodated within a case 110 of the battery module 150. Further, the direction of the x-axis of the coordinate system in FIGS. 4A-4C corresponds to the gravitational direction, in other words, the x-axis points downwards with respect to gravity.

The directions of the axes of the coordinate system depicted in FIGS. 1 and 2 and the directions of the respective axis of the coordinate system shown in FIGS. 4A-4C correspond to each other. Hence, each of the battery cells 1ᵢ₋₂, 1ᵢ₋₁, 1ᵢ, 1ᵢ₊₁, and 1₁₊₂ is mounted within the battery module 150 such that its respective upper side 12a faces upwards, i.e., against the x-direction, and its respective bottom side 12b faces downwards, i.e., into the x-direction.

As can be seen in each of FIGS. 4A-4C, each of the battery cells 1ᵢ₋₂, 1ᵢ₋₁, 1ᵢ, 1ᵢ₊₁, 1ᵢ₊₂ of battery cell stack 100 is placed with its respective bottom side 12b on a cooling plate 120. The bottom sides 12b may each be glued onto the cooling plate 120 using an adhesive layer of thermal interface material (TIM), as described above with reference to FIGS. 2A and 2B. The cooling plate 120 may be cooled by a cooling device, for example, a cooling channel arranged below the cooling plate 120 and in thermal contact with the cooling plate 120. Then, the cooling plate 120 can be cooled by guiding cooling liquid (e.g., coolant) through (e.g., flowing through) the cooling channel. Also, the temperature of the battery cells 1ᵢ₋₂, 1ᵢ₋₁, 1ᵢ, 1ᵢ₊₁, 1ᵢ₊₂ may be supervised by, for example, temperature sensors connected to a BMS/BMU.

FIG. 4A shows the battery module 150 in a normal working state, that is, in a state in which none of the battery cells 1ᵢ₋₂, 1ᵢ₋₁, 1ᵢ, 1ᵢ₊₁, 1ᵢ₊₂ are experiencing a thermal event, such as a thermal runaway. However, when a thermal event starts in one of the battery cells, for example, in battery cell 1ᵢ positioned in the center of the depicted portion of the battery cell stack 100, heat is generated such that the temperature of the electrolyte solution within the battery cell 1ᵢ rises, which eventually causes the electrolyte solution to evaporate. As a consequence, the pressure inside battery cell 1ᵢ rises and eventually, when a reference pressure value is reached or exceeded, triggers the venting valve 20 of battery cell 1ᵢ to open such that the vent gas (e.g., vaporized electrolyte solution) can escape through the vent opening O1 provided by the opened venting valve 20 to the outside of battery cell 1ᵢ (note that battery cell 1ᵢ is assembled according to the battery cell 1 shown in FIGS. 1-2B; thus, as to the details of the spatial arrangement of the venting valve 20 and the vent opening O1, see, e.g., FIGS. 1-2B as well as the respective description above). This venting of the vent gas is indicated in FIG. 4B by the two arrows pointing obliquely upwards from the battery cell 1ᵢ.

To stop the thermal event from occurring in battery cell 1ᵢ, the cooling performance of the cooler cooling the cooling plate can be increased. However, as explained above in the introductory part of the description, this will no longer be sufficient for the latest generation of battery cells.

As the thermal event proceeds and the temperature continues to rise, not only does the electrolyte evaporate but the electrode assembly within the battery cell 1ᵢ (e.g., the electrode stack 8 and/or the electric connections C₁, C₂) or at least parts of the electrode assembly melt (e.g., become molten) such that solid particles (e.g., graphite or copper particles) as well as molten metallic material are entrained with the vent gas and, thus, are also ejected through the vent opening O1 to the outside of the housing 10 of the battery cell 1ᵢ. Outside the battery cell 1ᵢ, the hot particles and the hot molten metallic material seriously damage the electric installations within the battery module 150 (e.g., the busbars). Eventually, the entire battery cell 1ᵢ may melt down.

Furthermore, other battery cells within the battery module 150 will likely be affected by such thermal runaway. For example, the battery cells 1ᵢ₋₁ and 1ᵢ₊₁ that are arranged directly adjacent to the battery cell 1ᵢ experiencing the thermal runway may undergo thermal runaway caused by direct heat transfer through the abutting front and rear sides of these battery cells. This procedure is indicated in FIG. 4C by the arrows pointing horizontally from the battery cell 1ᵢ to the next-neighboring (e.g., the directly adjacent) battery cells 1ᵢ₋₁ and 1ᵢ₊₁. Often, this process then continues to the second-next-neighbored battery cells 1ᵢ₋₂ and 1ᵢ₊₂ and so on.

Other battery cells (e.g., battery cells spaced apart from the battery cell 1ᵢ) within the battery module 150 can also be affected in that their respective opposite sides contact the hot particles and the hot molten metallic material ejected from battery cell 1ᵢ. Finally, due to such processes, the entire battery module 150 may be destroyed and the vehicle, into which the battery module 150 is implemented, may burn down.

A typical configuration of a battery pack currently used in electric vehicles is shown in FIG. 4A. Prismatic battery cells (see, e.g., FIGS. 1 and 2) may have a cuboid or hexagonal can with the positive and negative terminals at the top side of the can. A venting valve is also on the top side of the battery cell. The battery cells are then placed next to each other to form a battery cell stack, which may then be glued (e.g., by using a thermal interface material (TIM)) to a cooling plate. The cooling plate may have cooling channels through which a liquid coolant is circulated to control the temperature of the battery cells. This configuration has a relatively simple construction, low manufacturing cost, and good cooling performance. However, this cooling system, by itself, is not sufficient to prevent or stop thermal runaway because it cannot remove the massive amount of heat (e.g., about 1 MJ) that is generated in a short time (e.g., about 10 s) during a thermal runaway. In case of a thermal runaway, the affected battery cell first vents only hot gas (e.g., vent gas) but then also vents molten metallic materials through the vent opening formed after the venting valve opens (or bursts). This ejecta exits upwardly, where the ejecta has to navigate between the housing and electrical connectors (e.g., the bus bars). Finally, the ejecta reaches the venting valve of the housing and exits the battery pack to the environment.

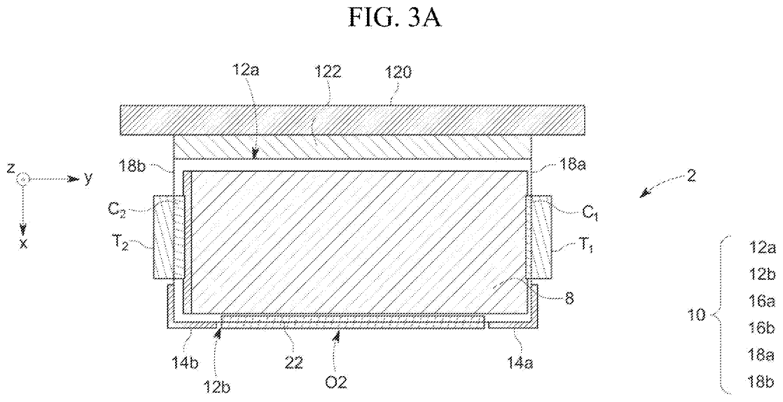

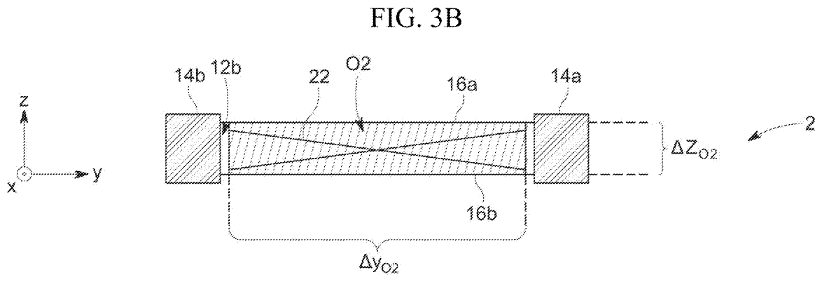

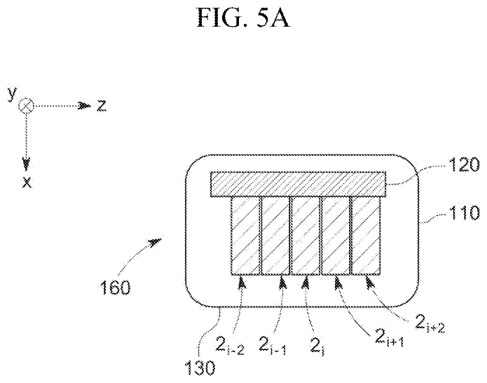

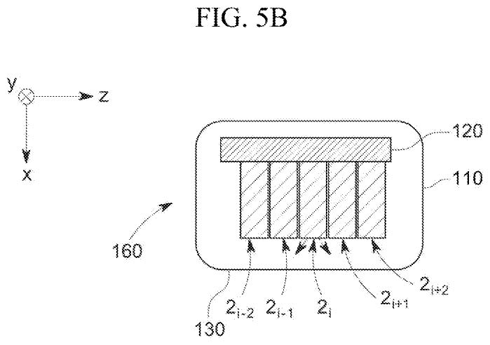

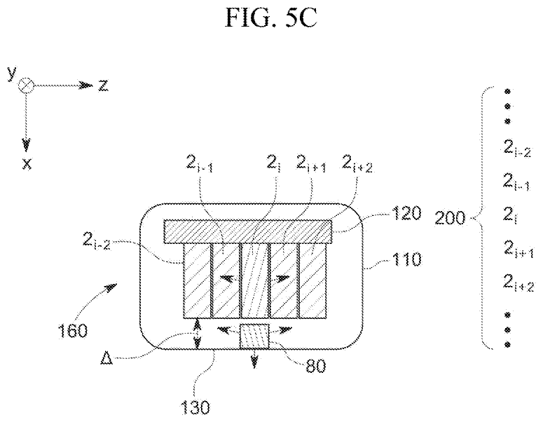

To prevent, in case of a thermal runaway occurring in one of the battery cells, propagation of the thermal runaway to adjacent battery cells as described in the foregoing with reference to FIGS. 4A-4C, a design of a battery cell as well as a design of a battery module is described in the following with reference to FIGS. 3A, 3B, and 5A-5C.

An embodiment of a battery cell 2 is schematically shown in FIGS. 3A and 3B. In more detail, FIG. 3A is a cross-sectional view of the battery cell 2, and FIG. 3B is a bottom view of the battery cell 2. Again, a Cartesian coordinate system having the x, y, and z axes is depicted merely to facilitate the description.

Similar to the conventional battery cell 1 depicted in FIG. 2, the battery cell 2 shown in FIGS. 3A and 3B includes a housing 10 having a prismatic (e.g., cuboid) shape. The housing 10 has an upper side 12a facing against the x-direction, a bottom side 12b facing into the x-direction, a first lateral side 18a facing into the y-direction, a second lateral side 18b facing against the y-direction, a front side 16a facing into the z-direction, a rear side 16b facing against the z-direction. The battery cell 2 may be configured to be mounted into a vehicle such that the bottom side 12b of the housing 10 faces the bottom side of the vehicle. Then, if the vehicle is positioned on a plane perpendicular to the direction of gravity, the bottom side 12b faces in the direction of the gravitational force. Also, a first terminal T₁ and a second terminal T₂ are arranged on the housing 10, along with a venting valve 22, on one of its side faces, wherein the venting valve 22 is configured to be the open state or to switch into the open state if the pressure inside the battery cell exceeds a reference value, and to remain in or switch into the closed state otherwise. In the open state, the venting valve 22 forms a vent opening O2 through the housing 10 of the battery cell 2. Furthermore, an electrode stack 8 is accommodated inside the battery cell housing 10 and is electrically connected, similar to the related art battery cell 1 shown in FIGS. 1 and 2, via a first electric connection C₁ with the first terminal T₁ and via a second electric connection C₂ with the second terminal T₂. The aspects and features of the battery cell 2 described so far substantially correspond to those of the battery cell 1 shown in FIGS. 1 and 2.

Different from the assembly of the related art battery cell 1 shown in FIGS. 2A and 2B, the terminals T₁, T₂ of the battery cell 2 shown in FIGS. 3A and 3B are not arranged on the same side face of the housing 10 as the venting valve 22. Rather, as can be seen in FIG. 3A, the terminals T₁, T₂ of the battery cell 2 are on the first lateral side 18a and the second lateral side 18b, respectively. Accordingly, the first and second lateral sides 18a, 18b may also be referred to as “terminal sides” hereinafter. When the battery cell 2 is mounted into a battery module (as will be discussed later with reference to FIGS. 5A-5C), the electrical components (e.g., busbars) can also be arranged adjacent to the first and second lateral sides 18a, 18b.

The battery cell 2 is configured to be used, within a battery module, in the orientation in space as illustrated in FIG. 3A, in which it is assumed that the x-axis is directed downwardly, that is, parallel to the gravitational force. Accordingly, the battery cell 2 has a different configuration than the related art battery cell 1 shown in FIGS. 2A and 2B in that—at least with regard to the cooling and the venting thereof—the roles of the upper side 12a and the bottom side 12b are reversed in comparison to the related art battery cell 1. For example, according to the design of the battery cell 2, the upper side 12a is configured as a cooling side instead of the bottom side 12b as in the related art battery cell 1. Further, the venting valve 22 is arranged in the bottom side 12b of the housing 10 of the battery cell 2, different from the venting valve 20 in the related art battery cell 1, which is positioned in the upper side 12a of battery cell 1 (see, e.g., FIGS. 1-2B). Accordingly, the bottom side 12b of the battery cell 2 may be referred to as “venting side” hereinafter.

According to above-described arrangement of the venting valve 22 in the battery cell 2 shown in FIG. 3, in case of a thermal runaway (e.g., in a state in which the venting valve 22 has been switched into the open state due to an overpressure inside the battery cell 2), any material to be ejected from the inside of battery cell 2 or any material that has become detached from its original positions within the housing 10 due to melting processes is not only conveyed to the outside of the battery cell 2 via the venting opening O2 due to the overpressure inside the battery cell 2 but also falls or streams through the venting opening O2 to the outside of the battery cell 2 by the gravitational force, which moves any detached (or unattached) material inside the battery cell 2 in the direction of the x-axis (assuming that the battery cell 2 is oriented such that the x-axis corresponds to the direction of the gravitational force).

Further, any loosened or detached material is removed from the inside of the housing 10 through the vent opening O2 provided by the opened venting valve 22 due to the increased area of the vent opening O2 of the battery cell 2 according to FIG. 3, which is significantly larger than the vent opening O1 of the related art battery cell 1 of FIGS. 1 and 2. For example, the vent opening O2 of battery cell 2 is at least 80% of the area of the bottom side 12b with respect to the y-direction and almost 100% (e.g., 98%) of the area of the bottom side 12b with respect to the z-direction. This is possible because the terminals have been moved from the side face of the housing 10 on which the venting valve 22 is arranged and are instead on the first and second lateral sides 18a, 18b, as described above. Thus, the area of the vent opening O2 provided by the venting valve 22 of battery cell 2 amounts to a multiplicity of the area of the vent opening O1 provided by the venting valve 20 of the related art battery cell 1 (e.g., at least 10 times the area; compare the length Δy_{O2} and the width Δz_{O2} of the vent opening O2 of battery cell 2 with the corresponding length Δy_{O1} and the width Δz_{O1} of the vent opening O1 of related art battery cell 1 in FIGS. 2A and 3B).

Consequently, not only small parts of molten and/or detached material, which can be entrained with the vent gas streaming through the vent valve 22, are ejected out of the battery cell 2 but also larger pieces of material up to the complete electrode assembly inside battery cell 2, depending on the material thereof and the specific dimensions of the area of the vent opening O2). For example, at least parts of the electrode stack 8 (e.g., the jelly roll) that are larger than about 50% of the size of the electrode stack in the original state (see, e.g., FIG. 3) with regard to the y-direction can be ejected to the outside of the battery cell 2 via the venting opening O2. As a result, a greater amount of hot (e.g., molten and solid) material is removed from the battery cell 2 when it experiences the thermal runaway in comparison to when the related art battery cell 1 experiences a thermal runaway. Also, the hot material is removed faster from the battery cell 2 when it is affected by a thermal runaway in comparison to the related art battery cell 1. Thus, the process of the thermal runaway within the battery cell 2 according to FIGS. 3A and 3B will be stopped automatically due to the afore-described features of the design of battery cell 2.

In the embodiment of the battery cell 2 shown in FIGS. 3A and 3B, the battery cell 2 can be mechanically supported, when being mounted into a battery module, on supports 14a, 14b at its bottom short side corners. Thus, in the illustrated embodiment, the area of the bottom side 12b that can be used for the vent opening O2 is confined, with regard to the y-direction, by the areas provided for mechanically supporting the battery cell 2. However, in other embodiments, mounting features may be alternatively provided on the first and second lateral sides 18a, 18b besides (or alongside) the terminals T₁, T₂ such that almost the entire length (along the y-direction) of the bottom side 12b may be used for the vent opening O2.

As in case of the related art battery cell 1 shown in FIGS. 2A and 2B, the battery cell 2 shown in FIGS. 3A and 3B may be cooled by the cooling plate 120. However, because the bottom side 12b of battery cell 2 is at where the venting valve 22 and the vent opening O2 are arranged, the bottom side 12b is no longer available for cooling. Hence, the upper side 12a is configured as a cooling side in the battery cell 2. This is no disadvantage in comparison to the arrangement in the conventional battery cell 1, as the area of the upper side 12a corresponds to (e.g., is substantially the same as) the area of the bottom side 12b in the illustrated embodiment. The mechanical and thermal connection of the upper side 12a of battery cell 2 to the cooling plate 120 may be similar to the mechanical and thermal connection of the bottom side 12b of conventional battery cell 1 to the respective cooling plate as described above with reference to FIGS. 2A and 2B. For example, the upper side 12a of battery cell 2 may be glued to the cooling plate 120 by using an adhesive layer 122 of thermal interface material (TIM).

The battery cell 2, according to an embodiment, is described in the foregoing with reference to FIGS. 3A and 3B, provides most benefit when a plurality of battery cells designed like the battery cell 2 shown in FIGS. 3A and 3B are used in a battery module and, in particular, when being assembled to a battery cell stack used in a battery module. This is now explained in more detail with reference to FIGS. 5A-5C.

FIGS. 5A-5C provide a schematic cross-sectional view of a battery module 160 including a battery cell stack 200. Apart from the battery cell stack 200, the battery module 160 may include further battery cell stacks. The battery cell stack 200 and, if applicable, the further battery cell stacks are accommodated within a case 110 of the battery module 160. Further, the direction of the x-axis of the coordinate system also shown in FIG. 5 corresponds to the direction of the gravitational force, in other words, the x-axis points downwardly.

The battery cell stack 200 includes a plurality of battery cells 2ᵢ₋₂, 2ᵢ₋₁, 2ᵢ, 2ᵢ₊₁, 2ᵢ₊₂ consecutively stacked together (e.g., arranged) along the z-direction. Each of the battery cells is assembled like the battery cell 2 described above in detail with reference to FIGS. 3A and 3B. Similar to the battery cell stack 100 employed in the related art battery module 150 described with respect to FIGS. 4A-4C, the battery cell stack 200 may include more battery cells than are depicted in FIGS. 5A-5C, for example, the stack of battery cells 212, 2ᵢ₋₁, 2ᵢ, 2ᵢ₊₁, and 2ᵢ₊₂ may be continued, with regard to the orientation of FIG. 5, to the left and/or the right by a plurality of further battery cells, which may also be designed like the battery cell 2 shown in FIGS. 3A and 3B. The terminals of the various battery cells included in battery cell stack 200 (see, e.g., terminals T₁ and T₂ in FIG. 3A) may be electrically interconnected to each other by busbars. Due to the terminals T₁, T₂ being arranged on the first and second lateral sides 18a, 18b of the battery cells 2ᵢ₋₂, 2ᵢ₋₁, 2ᵢ, 2ᵢ₊₁, 2ᵢ₊₂, the electrical interconnecting the terminals (e.g., the busbars) may also be positioned along the first and second lateral sides 18a, 18b of the battery cells 2ᵢ₋₂, 2ᵢ₋₁, 2ᵢ, 2ᵢ₊₁, 2ᵢ₊₂.

The directions of the axes of the coordinate system depicted in FIGS. 3A and 3B and the directions of the respective axis of the coordinate system shown in FIGS. 5A-5C correspond to each other. Hence, each of the battery cells 2ᵢ₋₂, 2ᵢ₋₁, 2ᵢ, 2ᵢ₊₁, and 2ᵢ₊₂ is mounted within the battery module 160 such that its respective upper side 12a faces upwardly, that is, against the x-direction, and its respective bottom side 12b faces downwardly, that is, into the x-direction.

As can be seen in each of FIGS. 5A-5C, each of the battery cells 2ᵢ₋₂, 2ᵢ₋₁, 2ᵢ, 2ᵢ₊₁, 2ᵢ₊₂ of battery cell stack 200 is connected, with its respective upper side 12a, to a cooling plate 120. For example, each of the upper sides 12a may be glued to the cooling plate 120 by using an adhesive layer of thermal interface material (TIM), as described above with reference to FIGS. 3A and 3B. The cooling plate 120 may be cooled by, for example, a cooling channel arranged above the cooling plate 120 in thermal contact with the cooling plate 120. Then, the cooling plate 120 may be cooled by guiding cooling liquid (e.g., coolant) through the cooling channel. Also, the temperature of the battery cells 2ᵢ₋₂, 2ᵢ₋₁, 2ᵢ, 2ᵢ₊₁, 2ᵢ₊₂ may be supervised (e.g., monitored) by temperature sensors connected to a BMS/BMU.

FIG. 5A shows the battery module 160 in a normal working state, that is, in a state in which none of the battery cells 2ᵢ₋₂, 2ᵢ₋₁, 2ᵢ, 2ᵢ₊₁, 2ᵢ₊₂ is undergoing (or experiencing) a thermal event, such as a thermal runaway. However, when a thermal event starts in one of the battery cells, for example, in the battery cell 2ᵢ positioned in the center of the depicted portion of the battery cell stack 200, heat is generated such that the temperature of the electrolyte solution within the battery cell 2ᵢ rises, which initially sets in motion similar processes as described above with reference to FIG. 4A. For example, the venting valve 22 of the battery cell 2ᵢ switches into an open state due to the overpressure generated within the housing of battery cell 2ᵢ and provides (or forms) a vent opening O2 such that vent gas (e.g., vaporized electrolyte solution) can escape through the vent opening O2 to the outside of the housing 10.

As the thermal event proceeds and the temperature rises further such that not only the electrolyte evaporates but also the electrode assembly within the battery cell 2ᵢ (e.g., the electrode stack 8 and/or the electric connections C₁, C₂) or at least parts of the electrode assembly become molten, solid particles (e.g., graphite or copper particles) as well as molten metallic material will be ejected through the vent opening O2 to the outside of the battery cell 2ᵢ. This is indicated in FIG. 5B by the two arrows pointing obliquely downwards from battery cell 2ᵢ.

However, because the vent opening O2 of battery cell 2ᵢ opens downwardly (e.g., into the direction of the gravitational force), in contrast to battery cell 1ᵢ shown in FIG. 4B, which is arranged on the top side of battery cell 1ᵢ, the efficiency of the ejecting process is increased in comparison to the corresponding situation in the conventional battery module 150 shown in, for example, FIG. 4B due to the gravitational force additionally acting on any loosened or detached material from the inside of the housing 10 as well as by the substantially enlarged area of the vent opening O2 of battery cell 2ᵢ in comparison to the area of the venting opening O1 of the related art battery cell 1ᵢ. Hence, the ejection process is faster and larger parts of the electrode assembly of battery cell 2ᵢ fall down (into the direction of the x-axis) through the vent opening O2 in comparison to the corresponding situation in the related art battery module 150 (see the above description of FIGS. 3A and 3B).

After being removed from the battery cell 2ᵢ, the ejected hot (e.g., solid or molten liquid) material parts 80 of the original electrode assembly of battery cell 2ᵢ are collected beneath the venting side 12b of battery cell 2ᵢ by a trough 130, as schematically illustrated in FIG. 5C. The trough 130 is arranged beneath the battery cells 2ᵢ₋₂, 2ᵢ₋₁, 2ᵢ, 2ᵢ₊₁, 2ᵢ₊₂ and spaced apart from the venting sides of the battery cells 2ᵢ₋₂, 2ᵢ₋₁, 2ᵢ, 2ᵢ₊₁, 2ᵢ₊₂ by a distance A. For example, the trough 130 forms a sufficiently sized void container located below the battery cells 2ᵢ₋₂, 2ᵢ₋₁, 2ᵢ, 2ᵢ₊₁, 2ᵢ₊₂ of the battery cell stack 200 to safely catch the ejected hot material parts 80. The trough 130 may be a collection plate. The trough 130 may be a bottom side of the case 110 of the battery module 160, which may be configured as a bollard protection plate.

Hence, after leaving the cell can, the solid and molten parts of the ejecta are caught by the trough, where they can spread out and cool down. Thus, in contrast to the situation in the related art battery module 150 illustrated in FIG. 4C, the ejected hot material parts 80 is no longer in thermal contact with the battery cells 2ᵢ₋₁ and 2ᵢ₊₁ arranged next to the battery cell 2ᵢ affected by the thermal runaway, nor can the ejected hot material parts 80 come in contact with electrical connectors T₁, T₂ of the remaining battery cells 2ᵢ₋₂, 2ᵢ₋₁, 2ᵢ₊₁, 2ᵢ₊₂ provided on the first and second lateral sides 18a, 18b of the battery cells 2ᵢ₋₂, 2ᵢ₋₁, 2ᵢ, 2ᵢ₊₁, 2ᵢ₊₂ or the electric interconnections between these connectors (e.g., busbars), which are also positioned along the first and second lateral sides 18a, 18b of the battery cells 2ᵢ₋₂, 2ᵢ₋₁, 2ᵢ, 2ᵢ₊₁, 2ᵢ₊₂.

Consequently, due to the design of the battery cells 2ᵢ₋₂, 2ᵢ₋₁, 2ᵢ, 2ᵢ₊₁, 2ᵢ₊₂ as well as of the battery module 160, the process of a thermal runaway is finally stopped inside the battery cell 2ᵢ and a propagation of the thermal runaway to other battery cells 2ᵢ₋₂, 2ᵢ₋₁, 2ᵢ₊₁, 2ᵢ₊₂ is prevented. A transfer of residual heat from battery cell 2ᵢ to the adjacent battery cells 2ᵢ₋₁ and 2ᵢ₊₁ is irrelevant or relatively small, and the respective heat energy it is not sufficient to initiate a further thermal runaway in the adjacent battery cells 2ᵢ₋₁ and 2ᵢ₊₁.

Because, as described before, the venting valves 22 of each of the battery cells 2ᵢ₋₂, 2ᵢ₋₁, 2ᵢ, 2ᵢ₊₁, 2ᵢ₊₂ of the battery cell stack 200 are placed at the bottom side 12b of their respective housings 10, the cooling plate 120 is located on the upper sides 12a of battery cells 2ᵢ₋₂, 2ᵢ₋₁, 2ᵢ, 2ᵢ₊₁, 2ᵢ₊₂. This provides at least the same cooling effect as in case of the related art battery module 150 where the cooling plate 120 is located on the bottom sides 12b of the respective battery cells 1ᵢ₋₂, 1ᵢ₋₁, 1ᵢ, 1ᵢ₊₁, 1ᵢ₊₂ (see, e.g., FIGS. 4A-4C). In fact, placing the cooling plate 120 on the upper sides 12a of battery cells 2ᵢ₋₂, 2ᵢ₋₁, 2ᵢ, 2ᵢ₊₁, 2ᵢ₊₂ has the advantage that heat exchange between the cooling plate 120 is located on the upper sides 12a of battery cells 2ᵢ₋₂, 2ᵢ₋₁, 2ᵢ, 2ᵢ₊₁, 2ᵢ₊₂ and the cooling plate 120 occurs at a hotter region of the battery cells 2ᵢ₋₂, 2ᵢ₋₁, 2ᵢ, 2ᵢ₊₁, 2ᵢ₊₂ during use and, thus, provides an improved efficiency because, due to the usual processes of heat transfer (e.g., convective transfer of heat by the electrolyte in the battery cell), upper regions tend to have a higher temperature than lower regions within a battery cell.

The design for a battery cell and a battery module as explained above with reference to FIGS. 3A-5C may be briefly summarized as follows: The housing of the proposed battery cell (see, e.g., FIGS. 3A and 3B) is built differently from that of a related art battery cell as shown in, for example, FIGS. 1-2B. For example, its terminals are located on either lateral side of the battery cell, and the electrical components (e.g., busbars) may be also arranged there. A cooling plate can be placed on the top side of the battery cell. The venting valve is placed at the bottom side. The battery cells may be supported on their corners (e.g., edges formed by their respective lateral and bottom sides), and a sufficiently sized void container (trough) is located below them.

In case of a thermal runaway, as pressure builds up within the affected battery cell, the respective venting valve opens and gas escapes. Due to gravity and internal pressure, any molten material or particle ejecta immediately leave downwardly. After leaving the battery cell housing, the ejecta are caught by the trough, where the ejecta can spread out and cool down. The hot material is no longer in contact with neighboring battery cells nor can it come in contact with electrical connectors.

This way it is ensured that thermal propagation is not possible.

Hence, aspects and features of embodiments of the present disclosure include:
The same cooling strategy can be used because the surface area available for cooling remains the same;
One cooling plate is sufficient;
The venting opening in the cell can be significantly enlarged because the terminals are not located on the same surface; and
A busbar design and complexity is only marginally affected.

### SOME REFERENCE SIGNS

1 related art battery cell
1ᵢ₋₂, 1ᵢ₋₁, 1ᵢ, 1ᵢ₊₁, 1ᵢ₊₂ related art battery cells
2 battery cell
2ᵢ₋₂, 2ᵢ₋₁, 2ᵢ, 2ᵢ₊₁, 2ᵢ₊₂ battery cells
10 housing
12a upper side
12b bottom side
14a, 14b support
16a front side
16b rear side
18a first lateral side
18b second lateral side
20 venting valve
22 venting valve
80 ejected hot material parts
100 battery cell stack
110 case of battery module
120 cooling plate
122 adhesive layer of thermal interface material (TIM)
130 trough
150 battery module
160 battery module
200 battery cell stack
C₁ first electric connection
C₂ second electric connection
Δ distance
Δy_{O1}, Δz_{O1} dimensions of the vent opening (state of the art)
Δy_{O2}, Δz_{O2} dimensions of the vent opening
O1 vent opening (state of the art)
O2 vent opening
T₁ first terminal
T₂ second terminal
x, y, z axes of a Cartesian coordinate system

What is claimed is:

1. A battery cell comprising:
a housing having a prismatic shape with a venting side and a terminal side that is different from the venting side;
an electrode assembly inside the housing;
a terminal arranged on the terminal side; and
a venting valve on the venting side, the venting valve being configured to switch between an open state and a closed state,
wherein the venting valve, when in the open state, forms a vent opening in the venting side of the housing, the vent opening being at least 15% of the total area of the venting side.

2. The battery cell according to claim 1, wherein the venting side is a bottom side of the battery cell in a gravitational direction.

3. The battery cell according to claim 1, wherein the vent opening is configured to let molten material and particles from the inside of the housing to pass to outside of the housing.

4. The battery cell according to claim 3, wherein the vent opening is configured to let parts of the electrode assembly pass from the inside of the housing to the outside of the housing.

5. The battery cell according to claim 1, wherein the electrode assembly is fixed inside the battery cell by an anchorage, and
wherein the electrode assembly is configured to slide through the venting opening when the venting valve is in the open state and the electrode assembly has detached from the anchorage.

6. The battery cell according to claim 1, wherein the venting opening is at least 90% of the total area of the venting side.

7. The battery cell according to claim 1, wherein the venting opening opens the venting side between 98% and 100% of its total surface area.

8. The battery cell according to claim 1, wherein the housing has two terminal sides arranged on opposite sides of the housing.

9. The battery cell according to claim 8, wherein one side of the housing is a cooling side.

10. A battery module comprising a plurality of battery cells, each of the battery cells being the battery cell according to claim 1,
wherein each of the battery cells is arranged such that the venting side of the battery cell faces into a first direction.

11. The battery module according to claim 10, further comprising a trough,
wherein the trough extends parallel to the venting side of each of the battery cells, is positioned in front of the venting side of each of the battery cells, and is arranged spaced apart from the venting side of each of the battery cells in the first direction.

12. The battery module according to claim 11, wherein the trough is formed by a bollard protection plate.

13. The battery module according to claim 10, further comprising a cooling plate in thermal connection to a cooling side of each of the battery cells,
wherein the cooling side of each of the battery cells faces in a second direction.

14. A battery system comprising a plurality of the battery cells according to claim 1.

15. A battery system comprising the battery module according to claim 10.

16. A vehicle comprising the battery module according to claim 10.

17. A vehicle comprising the battery system according to claim 14.
